(19) United States
(12) Patent Application Publication
(10) Pub. No.: US 2013/0159844 A1
(43) Pub. Date: Jun. 20, 2013

(54) DATA PROCESSING APPARATUS, NON-TEMPORARY RECORDING MEDIUM, AND DATA PROCESSING METHOD

(71) Applicant: KYOCERA Document Solutions Inc., Osaka (JP)

(72) Inventor: Takashi TAMURA, Osaka (JP)

(73) Assignee: KYOCERA DOCUMENT SOLUTIONS INC., Osaka (JP)

(21) Appl. No.: 13/715,463

(22) Filed: Dec. 14, 2012

(30) Foreign Application Priority Data
Dec. 16, 2011 (JP) 2011-276514

(51) Int. Cl. G06F 17/21

(52) U.S. Cl. CPC G06F 17/217
USPC 715/251

(57) ABSTRACT

A control unit of a personal computer (PC) 1 functions as a document data acquisition portion, an analysis portion, a page break processing portion, and an output portion. The document data acquisition portion acquires document data from a word processor or the like according to a data processing program stored in an HDD. The analysis portion analyzes characters constituting the acquired document data. When the analyzed characters indicate a first character, the page break processing portion performs page break processing at a position of the first character. The output portion outputs the document data that has undergone the page break processing to a printer driver portion.

### REFERENCE TO RELATED APPLICATIONS

This application is based upon and claims the benefit of priority from the corresponding Japanese Patent Application No. 2011-276514, filed in the Japan Patent Office on Dec. 16, 2011, the entire contents of which are incorporated herein by reference.

### BACKGROUND

The present invention relates to a data processing apparatus, a non-temporary recording medium and a data processing method.

A personal computer and the like having the function of a text editor or a word processor receives inputs of codes for line feed and page break by an operator when he or she inputs characters, and creates document data built according to a layout expressed with the input alphanumeric characters and code characters for line feed and page break. Additionally, a label production apparatus has been known which can produce an easily viewable label by creating a desired layout by inputting codes for line feed and block feed and setting an independent format for each line.

Here, as a method for extracting new ideas in an actual business environment or the like, brain storming method is available. This method takes a procedure of: (1) when extracting an idea, successively writing down ideas which a person has conceived on a whiteboard or the like; or (2) writing down a single idea on a single sticky note and pasting the sticky notes successively. Furthermore, a procedure (3) of inputting ideas randomly into a personal computer having a function as a word processor, text editor or the like may be adopted.

To create ideas effectively and arrange the created ideas by the brain storming method, it is required to write down a single idea on a single sticky note so that the ideas can be extracted afterward and convert the proposed idea into electronic data.

However, in the brain storming methods (1), (2) by writing down by hand, it takes time and labor to input the document written by hand into a personal computer in order to keep the proposed ideas in the form of electronic data. In the brain storming method (3) by writing down using the personal computer, if the number of ideas is large, work for setting the computer to print a single idea on a single sticky note is complicated.

### SUMMARY

A first disclosure provides a data processing apparatus including a document data acquisition portion, an analysis portion, a page break processing portion, and an output portion. The document data acquisition portion acquires document data. The analysis portion analyzes characters constituting the document data acquired by the document data acquisition portion. The page break processing portion, when the character analyzed by the analysis portion indicates a predetermined first character, performs page break processing at a position of the first character. The output portion outputs the document data that has undergone the page break processing by the page break processing portion.

A second disclosure provides a non-temporary recording medium that records a data processing program configured to make a computer function and is computer-readable, wherein the data processing program makes a computer function as a document data acquisition portion, an analysis portion, a page break processing portion, and an output portion. The document data acquisition portion acquires document data. The analysis portion analyzes characters constituting the document data acquired by the document data acquisition portion. The page break processing portion, when a character analyzed by the analysis portion indicates a predetermined first character, performs page break processing at a position of the first character. The output portion outputs the document data that has undergone the page break processing by the page break processing portion.

A third disclosure provides a data processing method including document data acquisition step, analysis step, page break processing step, and output step. The document data acquisition step acquires document data. The analysis step analyzes characters constituting the document data acquired by the document data acquisition step. The page break processing step, when the characters analyzed by the analysis step indicate a predetermined first character, performs the page break processing at a position of the first character. The output step outputs the document data that has undergone the page break processing by the page break processing step.

### BRIEF DESCRIPTION OF DRAWINGS

FIG. 1 is a block diagram showing schematically an internal configuration of a personal computer according to an embodiment of a data processing apparatus of the present invention.

FIG. 2 is a flow chart showing a first embodiment of execution processing of a print job with a personal computer.

FIG. 3 is a diagram showing an example of a display screen of a display portion.

FIG. 4A is a diagram showing a layout of a document expressed by document data created with a word processor.

FIG. 4B is a diagram showing a layout of a document expressed by document data after page break processing is performed.

FIG. 5 is a flow chart showing a second embodiment of execution processing of a print job with a personal computer.

FIG. 6 is a diagram showing an example of a display screen of a display portion.

FIG. 7A is a diagram showing a layout of a document expressed by document data created with a word processor.

FIG. 7B is a diagram showing a layout of a document expressed by document data after page break processing is performed.

FIG. 7C is a diagram showing a layout of a document expressed by document data after aggregation processing is performed.

FIG. 8 is a flow chart showing a third embodiment of execution processing of a print job with a personal computer.

FIG. 9 is a flow chart showing a fourth embodiment of execution processing of a print job with a personal computer.

FIG. 10 is a diagram showing an example of a display screen of a display portion.

FIG. 11A is a diagram showing a layout of a document expressed by document data after page break processing is performed.

FIG. 11B is a diagram showing a layout of a document expressed by document data after reallocation processing is carried out based on grouping.

FIG. 12A is a diagram showing an order of paragraphs before grouping, allocated in document data without page break.

FIG. 12B is a diagram showing an order of paragraphs grouped depending on a number of second characters.

FIG. 13 is a flow chart showing a fifth embodiment of execution processing of a print job with a personal computer.

FIG. 14 is a diagram showing an example of a display screen of a display portion.

FIG. 15A is a diagram showing an order of grouped page-unit data.

FIG. 15B is a diagram showing a state in which the order of the grouped page data is changed depending on the number of their rows.

FIG. 16 is a flow chart showing a sixth embodiment of execution processing of a print job with a personal computer.

### DETAILED DESCRIPTION

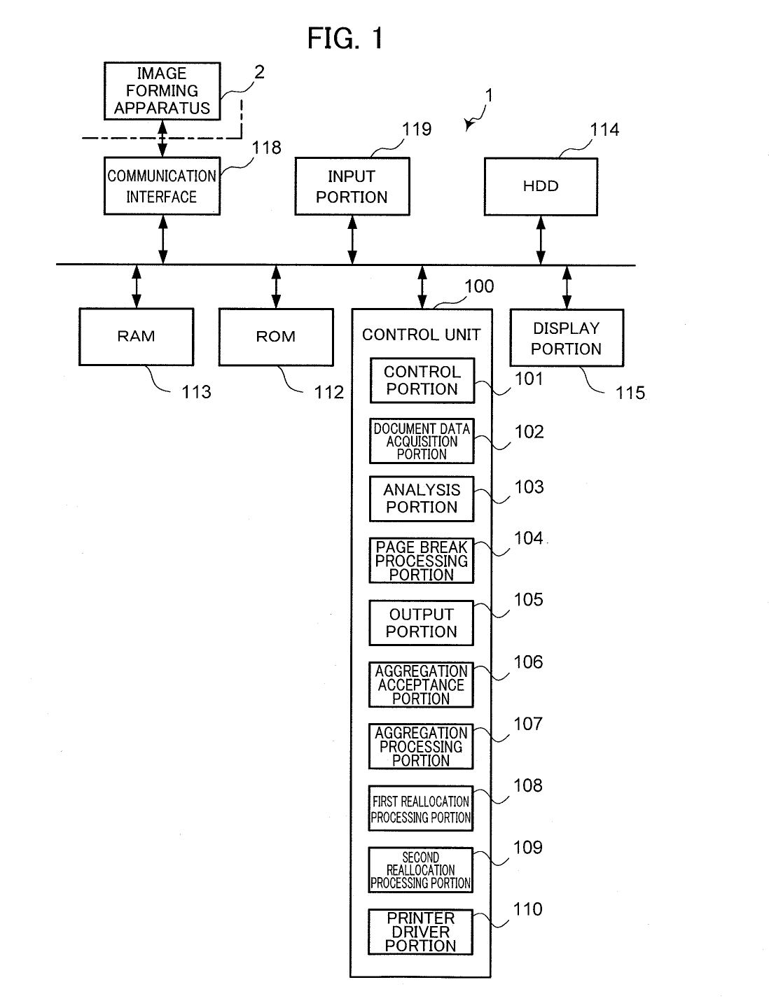

Hereinafter, a data processing program and a data processing apparatus according to an embodiment of the present invention will be described with reference to the accompanying drawings. FIG. 1 is a block diagram showing schematically an internal configuration of a personal computer according to an embodiment of a data processing apparatus of the present invention.

The personal computer (hereinafter referred to as PC) 1 as an embodiment of the data processing apparatus of the present invention includes a control unit 100, a ROM 112, a RAM 13, a HDD 114, a display portion 115, a communication interface 118, and an input portion 119. The respective components can exchange data or signals with each other through a CPU bus.

The control unit 100 is constituted of a CPU or the like and controls the operation of an entirety of the PC 1. The ROM 12 stores an operation program about a basic operation of the PC 1. The RAM 113 is used as an operation area of the control unit 100.

The HDD 114 stores a variety of data such as document data and image data which are printing objects in a part of its storage area. A data processing program according to an embodiment of the present invention is stored in the HDD 114. The control unit 100 is activated according to the data processing program and functions as a control portion 101, a document data acquisition portion 102, an analysis portion 103, a page break processing portion 104, an output portion 105, an aggregation acceptance portion 106, an aggregation processing portion 107, a first reallocation processing portion 108, and a second reallocation processing portion 109. Performance of the data processing program which makes the control unit 100 function as the aggregation acceptance portion 106, the aggregation processing portion 107, the first reallocation processing portion 108 and the second reallocation processing portion 109 is sufficient as long as the data processing program has only necessary performances in following embodiments. The control portion 101, the document data acquisition portion 102, the analysis portion 103, the page break processing portion 104, the output portion 105, the aggregation acceptance portion 106, the aggregation processing portion 107, the first reallocation processing portion 108, and the second reallocation processing portion 109 of the control unit 100 may be configured of each hardware circuit if they are not activated based on the image formation program. Hereinafter, the same is applied to the following embodiments unless otherwise mentioned.

The display portion 115 is configured of a liquid crystal display (LCD) or the like. An operation guide for an operator of the PC 1 is displayed on the display portion 115. The communication interface 118 functions as an interface that executes data communication between the PC 1 and an image forming apparatus 2 such as a printer or multifunctional peripheral connected thereto.

The input portion 119 is configured of a keyboard or a mouse. A job for printing document data created with a text editor or a word processor is input to the input portion 119 by an operator. The input jobs are an instruction for specifying document data stored in the HDD 114 or document data created by way of application such as a word processor implemented in the PC 1 and an instruction for executing a print job. For example, as the print job, the input portion accepts an input about an instruction for each function such as document size, document setting, document reading resolution, file format, color/monochrome print, whether execution of brain storming print mode (described in detail below) is required, and the like from an operator. However, the kind of instructions which the input portion accepts from the operator is not limited to these.

As described above, the control unit 100 includes the control portion 101, the document data acquisition portion 102, the analysis portion 103, the page break processing portion 104, the output portion 105, the aggregation acceptance portion 106, the aggregation processing portion 107, the first reallocation processing portion 108, and the second reallocation processing portion 109.

The control portion 101 controls an entirety of an operation of the PC 1. When a print job is input, the control portion 101 accepts an execution instruction of brain storming print from an operator via the input portion 119. The brain storming print refers to a print style of, when a print job is executed, printing a text (paragraph) contained in document data created with a word processor such that each text set by an operator is printed on an independent recording paper.

The control portion 101 controls display of the display portion 115 and for example, displays a guide having a message which urges the operator to input an instruction about a print job on the display portion 115.

The document data acquisition portion 102 acquires document data created with an application such as a word processor from the application. For example, when an operator inputs an execution instruction of a print job by means of a function of the word processor after the operator creates a document data with the word processor, the document data acquisition portion 102 acquires document data from the word processor.

The analysis portion 103 analyzes document data acquired from an application such as a word processor by the document data acquisition portion 102 and specifies a content of each character such as letter, symbol, line feed, page break, which constitute the document data.

When the character analyzed by the analysis portion 103 indicates a predetermined first character, the page break processing portion 104 executes page break processing at a position of the first character. As the first character, of characters which can be input with a word processor or the like, a particular character is specified at the time of shipment of the PC 1 or shipment of a data processing program. For example, line feed code is adopted as the first character. The first character is stored in the page break processing portion 104. In addition, the first character may be specified or changed by operator's operating the input portion 119.

The output portion 105 outputs document data which has undergone page break processing by the page break processing portion 104 to a printer driver portion 110 or the like. After the page break processing is carried out by the page break processing portion 104, the output portion 105 restructures the document data which has undergone the page break processing and outputs the restructured document data to the printer driver portion 110.

The aggregation acceptance portion 106 accepts a setting content of the aggregation processing from the operator. For example, when the aggregation acceptance portion 106 accepts an execution instruction of brain storming print from the operator upon input of a print job, it accepts an instruction for executing the aggregation processing on the document data which has undergone the page break processing or an instruction for setting an aggregation content about how many pages of texts are printed on a single recording paper, from the operator through an operation of the input portion 119.

The aggregation processing portion 107 executes aggregation processing to the document data which has undergone the page break processing depending on the setting content accepted by the aggregation acceptance portion 106.

Of texts of respective page-units (data of each page-unit) constituting document data which has undergone the page break processing, the first reallocation processing portion 108 extracts page-unit data having predetermined second characters residing in the same number continuously at least at a head of the text or an end of the text and allocates the extracted page-unit data in line continuously. That is, the first reallocation processing portion 108 groups the respective page-unit data depending on the number of the second characters located at the head of a text. Then, of the page-unit data classified by the grouping, the first reallocation processing portion 108 changes the layout such that the page-unit data in the same group are arranged in line continuously to allocate those page-unit data.

As the second character, a particular character different from the above-mentioned first character is specified of characters which can be input with a word processor or the like at the time of shipment of the PC 1 or shipment of the data processing program. The second character is stored in the first reallocation processing portion 108. For example, a code of space (space code) indicating a blank in which no letter or symbol exits is adopted as the second character. The second character may be specified or changed by operator's operating the input portion 119. Of the respective page-unit data which have undergone the page break processing, the first reallocation processing portion 108 extracts page-unit data having space codes as the second character residing in the same number continuously at the head of the text and then, changes the document layout indicated by the document data such that the extracted page-unit data are arranged continuously in line.

The second reallocation processing portion 109 detects a number of rows constituting each page-unit data after undergoing the page break processing by the page break processing portion 104, and reallocates the page-unit data such that respective character groups having the same number of rows are arranged in line continuously. The second reallocation processing portion 109 groups the respective page-unit data (the respective page-unit data in which page-unit data having the same number of the second characters are aggregated in the case of reallocation processing by the first reallocation processing portion 108) contained in the document data after the page break processing into page-unit data having each equal number of rows and changes the document layout indicated by the document data such that the page-unit data constituting a group are arranged in line continuously.

In addition, the control unit 100 also functions as a printer driver portion 110 when being activated according to an application of a printer driver stored in the HDD 114.

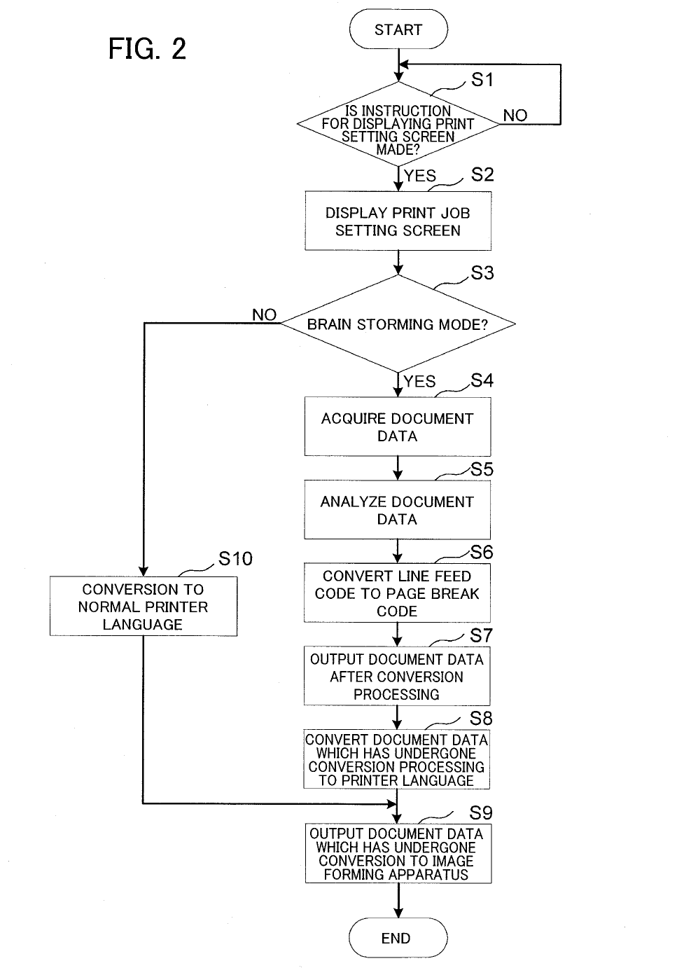

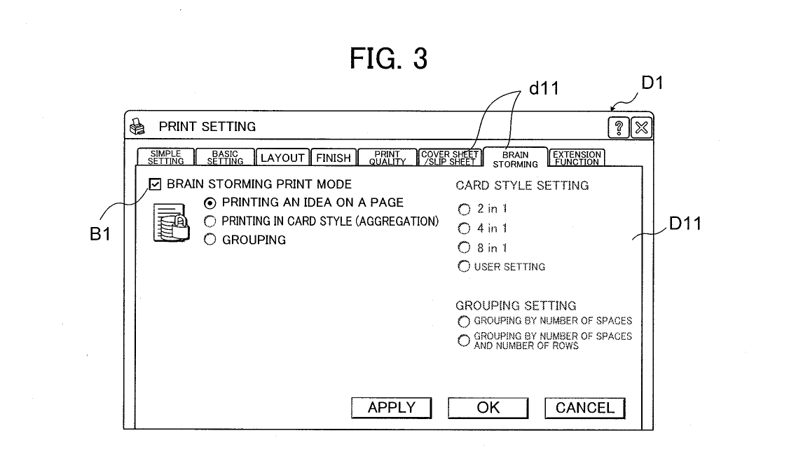

Next, a first embodiment of the execution processing of a print job with the PC 1 will be described. FIG. 2 is a flow chart showing a first embodiment of the execution processing of a print job with a personal computer. FIG. 3 is a diagram showing an example of the display screen of a display portion. Hereinafter, a case in which the print job is executed with respect to document data created with a word processor will be described.

On the PC 1, document data created with a word processor is specified by an operator and an instruction for displaying a print job setting screen is input by operating the input portion 119 (YES in S1). Then, the control portion 101 displays the print job setting screen on the display portion 115 (S2).

As exemplified in FIG. 3, the print job setting screen D1 is a screen which has a plurality of setting screens which can be changed over by an operator operating the input portion 119 to accept an input of an instruction about functions such as recording paper size, margin space, print direction, double-sided/single-sided print, color/monochrome print, whether brain storming print is necessary and the like. The change-over of the display screen is implemented by the control portion 101.

In the present embodiment, the print job setting screen D1 is a part of a display screen which accepts a print setting through a printer driver for printing document data created with a word processor.

The print job setting screen D1 has tabs d11 indicating an item which can be accepted by the above-mentioned respective setting screens. When an operator operates the input portion 119 to select a tab d11 indicating his or her desired item and then inputs an instruction for displaying a setting screen for accepting the item indicated by the selected tab d11, the control portion 101 displays the setting screen corresponding to the item indicated by the selected tab d11 on the display portion 115. FIG. 3 shows a case where the brain storming setting screen D11 for accepting an item setting under the brain storming print mode is displayed according to a display instruction from the operator. Hereinafter, assume that the control portion 101 displays the brain storming setting screen D11 on the display portion 115 and the operator executes an operation for the item setting for the brain storming print on the brain storming setting screen D11.

When the brain storming setting screen D11 is displayed, the operator operates the input portion 119 to input an execution instruction of the brain storming print mode (YES in S3). Then, the execution instruction of the brain storming print mode is accepted by the control portion 101.

For example, when, on the brain storming setting screen D11 shown in FIG. 3, the operator specifies a radio button B1 indicating “brain storming print mode” by operating a mouse pointer serving as the input portion 119, the execution instruction of the brain storming print mode is accepted by the control portion 101.

When the execution instruction of the brain storming print mode is accepted by the control portion 101, the document data acquisition portion 102 acquires the above-mentioned document data created with a word processor from the word processor (S4).

Subsequently, the analysis portion 103 analyzes the document data acquired from the word processor and specifies a content of each character such as letters, symbols, line feed, page break, space which constitute the document data (S5).

From a result of the analysis by the analysis portion 103, the page break processing portion 104 extracts a character indicating a line feed code and converts the line feed code to a page break code to execute page break processing (S6).

After the page break processing, the output portion 105 outputs the document data to the printer driver portion 110 (S7). The printer driver portion 110 receives the document data and converts the document data to a printer language corresponding to the image forming apparatus 2 connected to a network (S8). After conversion to the printer language, the printer driver portion 110 outputs the document data from the communication interface 118 to the image forming apparatus 2 (S9).

That is, the above-described processing of S4 to S7, i.e., a processing of the data processing apparatus according to an embodiment of the present invention including the document data acquisition portion 102, the analysis portion 103, the page break processing portion 104, and the output portion 105 is interposed between a word processor and the printer driver portion 110, and applies a processing by the page break processing (S6) to the document data created with a word processor, and then, supplies the processed document data to the printer driver portion 110. The printer driver portion 110 converts the received document data to the printer language in the same way as the document data received from the word processor and outputs the document data which has undergone the conversion processing to the corresponding image forming apparatus 2. Furthermore, the printer driver portion 110 converts the received document data to the printer language according to other setting which accepts an instruction from the operator as a function inherent of the printer driver.

In S3, unless, when the brain storming setting screen D11 is displayed, the execution instruction of the brain storming print mode is input by operator's operating the input portion 119 (NO in S3), the printer driver portion 110 converts the document data acquired from the word processor to the printer language (S10) without executing the above page break processing and then, outputs to the image forming apparatus 2 (S9). That is, the document data is converted as usual.

According to the first embodiment, if when inputting letters or symbols with a word processor, the operator creates document data by inputting the predetermined first character (in the present embodiment, line feed code) into a desired position, the document data is acquired by the document data acquisition portion 102. Consequently, a page is broken at a position where the first character (line feed code) is input, so that each text (paragraph) contained in the document data is printed on a separated page. Thus, if the operator executes an operation of inputting the first character (line feed code) at a desired position with a word processor, the text can be printed on each separate recording paper each time when the first character (line feed code) input position appears.

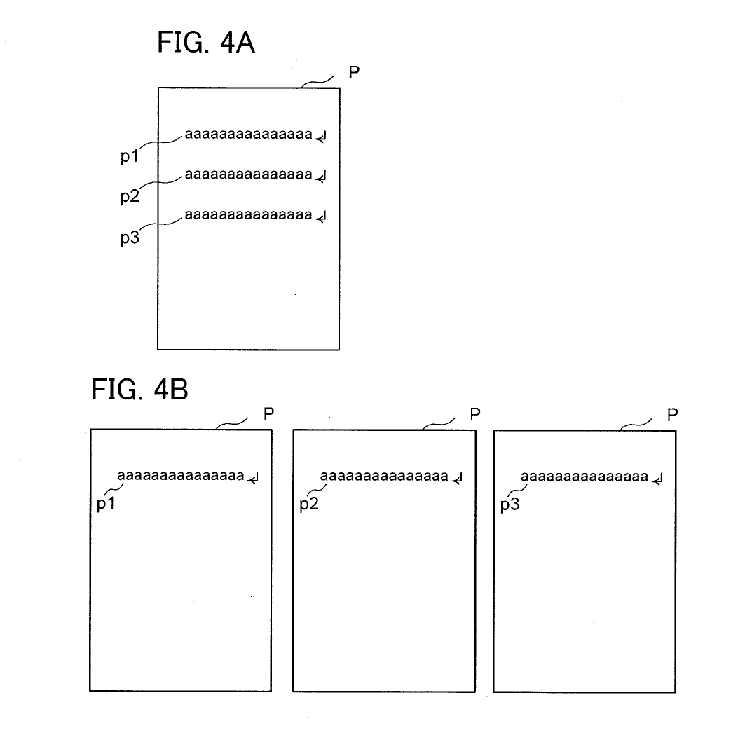

FIG. 4A shows a layout of a document expressed by document data created with a word processor. FIG. 4B shows a layout of a document expressed by document data after page break processing is performed.

For example, according to the processing of the first embodiment, in a layout where, as shown in FIG. 4A, document data created with a word processor contains three line feed codes, and three paragraphs p1, p2, p3 are printed on a page (single piece) of the recording paper P, the document data undergoes the page break processing at each line feed position after the processing of S4 to S7. Consequently, as shown in FIG. 4B, the paragraphs p1, p2, p3 are changed into a layout where they are printed on different recording paper P.

As a result, when extracting an idea according to the brain storming method, each proposed idea can be converted to electronic data by inputting letters and symbols through a personal computer (in the present embodiment, PC 1) having a function such as a text editor or a word processor, and a print in a print style demanded by the brain storming, i.e., in a style of printing each text indicating an idea on each recording paper can be implemented by an easy operation.

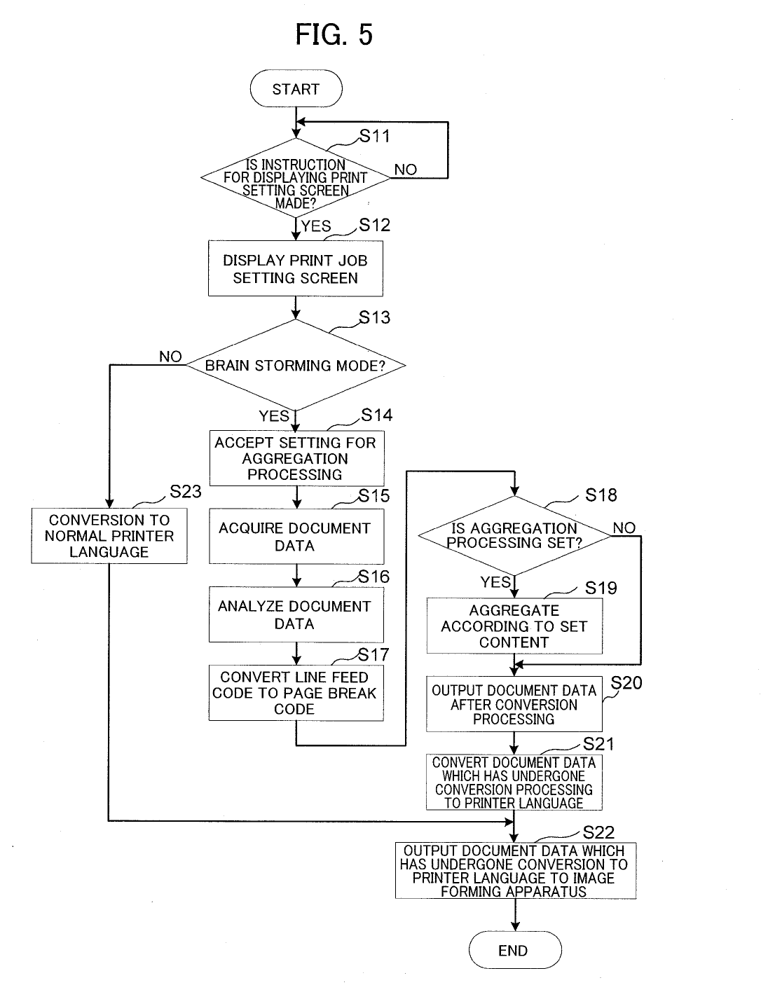

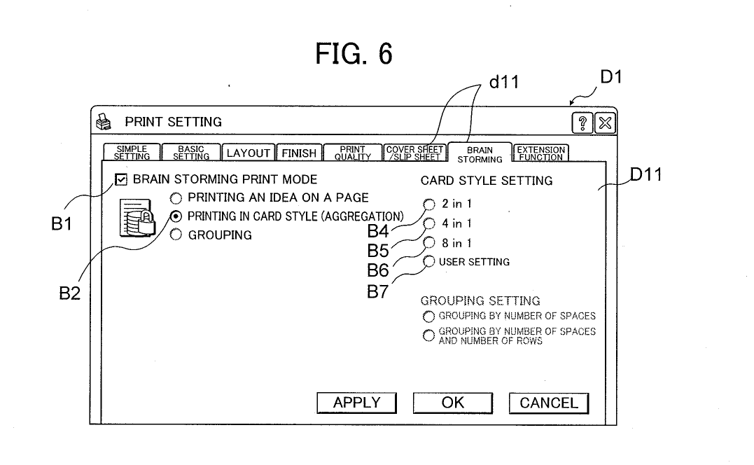

Next, a second embodiment of the execution processing of a print job with the PC 1 will be described. FIG. 5 is a flow chart showing a second embodiment of the execution processing of a print job. FIG. 6 is a diagram showing an example of the display screen of the display portion. Description of the same processing as the first embodiment is omitted.

According to a second embodiment, when the brain storming setting screen D11 is displayed, an execution instruction of the brain storming print mode is input by operator's operating the input portion 119 (YES in S13). Then, the aggregation acceptance portion 106 accepts a setting for aggregation processing by the operator at his or her disposal (S14). The document data acquisition portion 102 acquires document data from a word processor (S15).

For example, as shown in FIG. 6, the operator specifies the radio button B1 indicating “brain storming print mode” by operating a mouse pointer serving as the input portion 119 on the brain storming setting screen D11, and additionally, specifies a radio button B2 indicating “card style print (aggregation style)”. Then, the control portion 101 controls the display portion 115 to change a display portion of the “card style setting” for accepting a setting of the aggregation processing, indicated adjacent to the display portions of the “brain storming print mode” and “card style print (aggregation style)” from gray-out to a display indicating a state allowing the acceptance of the instruction.

With this state, the operator specifies any one of radio buttons B4, B5, B6, B7 indicating “2 in 1”, “4 in 1”, “8 in 1”, and “user setting”, respectively in the “card style setting” display area by operating a mouse pointer serving as the input portion 119. Then, the aggregation acceptance portion 106 accepts any aggregation instruction of 2 in 1 (aggregating two pages into one page), 4 in 1 (aggregating four pages into one page), 8 in 1 (aggregating eight pages into one page), and “user setting”, indicated at a position corresponding to the specified radio button.

After that, analysis of the document data by the analysis portion 103 (S16) and the page break processing by the page break processing portion 104 (S17) are carried out. After that, the aggregation processing portion 107 determines whether an aggregation instruction is set by the operator (S18). When it is determined that the aggregation instruction is set by the operator (YES in S18), the aggregation processing portion 107 aggregates respective page-unit data classified by the page break code gained by conversion of the line feed code in the page break processing, according to an aggregation content set by the aggregation instruction by the operator in S15, into a page unit specified by the aggregation instruction (S19).

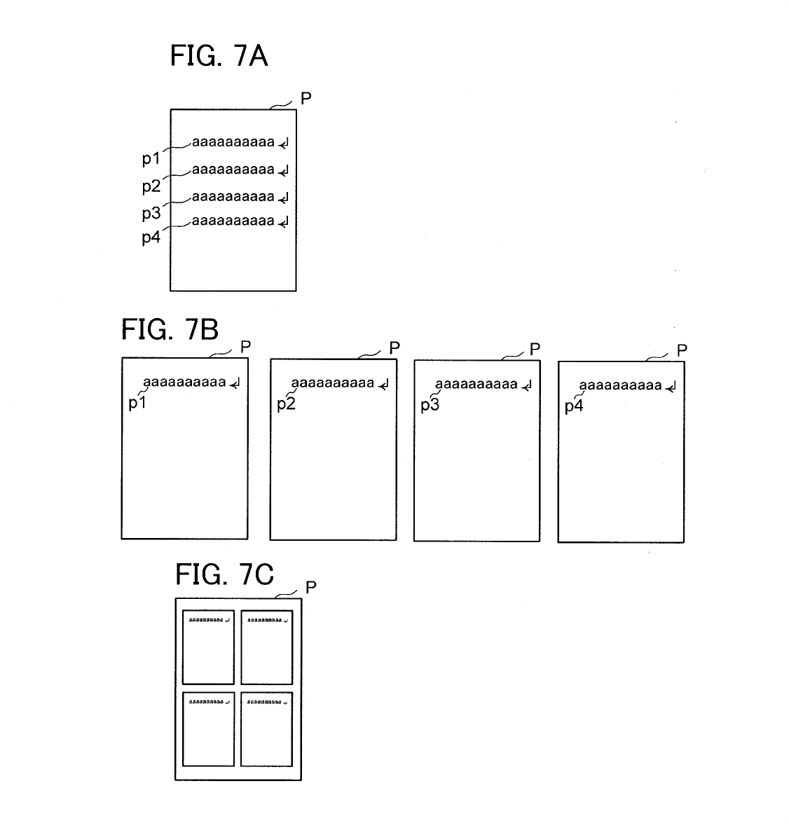

FIG. 7A shows a layout of a document expressed by document data created with a word processor. FIG. 7B shows a layout of the document expressed by document data after the page break processing is performed. FIG. 7C shows a layout of the document expressed by document data after the aggregation processing is performed.

For example, in a layout where, as shown in FIG. 7A, document data created with a word processor contains four line feed codes and four paragraphs p1, p2, p3, p4 are printed on a page (single piece) of the recording paper P, a layout where four paragraphs p1, p2, p3, p4 are printed on different recording papers P as shown in FIG. 7B is produced after the page break processing is performed. When the setting for the aggregation processing by the operator is 4 in 1 as mentioned above, the aggregation processing portion 107 aggregates the respective page-unit data (for four pages) into a page as shown in FIG. 7C. That is, the original layout of the document data created with the word processor (a layout where the four paragraphs p1, p2, p3, p4 are printed in four lines on a page of the recording paper. See FIG. 7A) is changed to a card style layout where the respective page-unit data of four pages are printed on a page as shown in FIG. 7C.

On the other hand, when the aggregation processing portion 107 determines that no aggregation instruction is set by the operator (NO in S18), a processing of S19 is skipped, so that no aggregation processing by the aggregation processing portion 107 is performed.

After that, the output portion 105 outputs the document data which has undergone the aggregation processing to the printer driver portion 110 (S20). The printer driver portion 110 converts the document data to a printer language corresponding to the image forming apparatus 2 connected to a network (S21) and after the conversion to the printer language, outputs the document data to the image forming apparatus 2 (S22).

According to the second embodiment, by operator's performing an operation for making the aggregation acceptance portion 106 accept a setting content of the aggregation processing, when extracting an idea according to the brain storming method, which texts indicating each idea should be printed on independent recording papers or the texts (paragraphs) indicating a plurality of ideas should be printed collectively on a single recording paper, for example, in the card style, can be selected by an easy operation and the selected method can be executed.

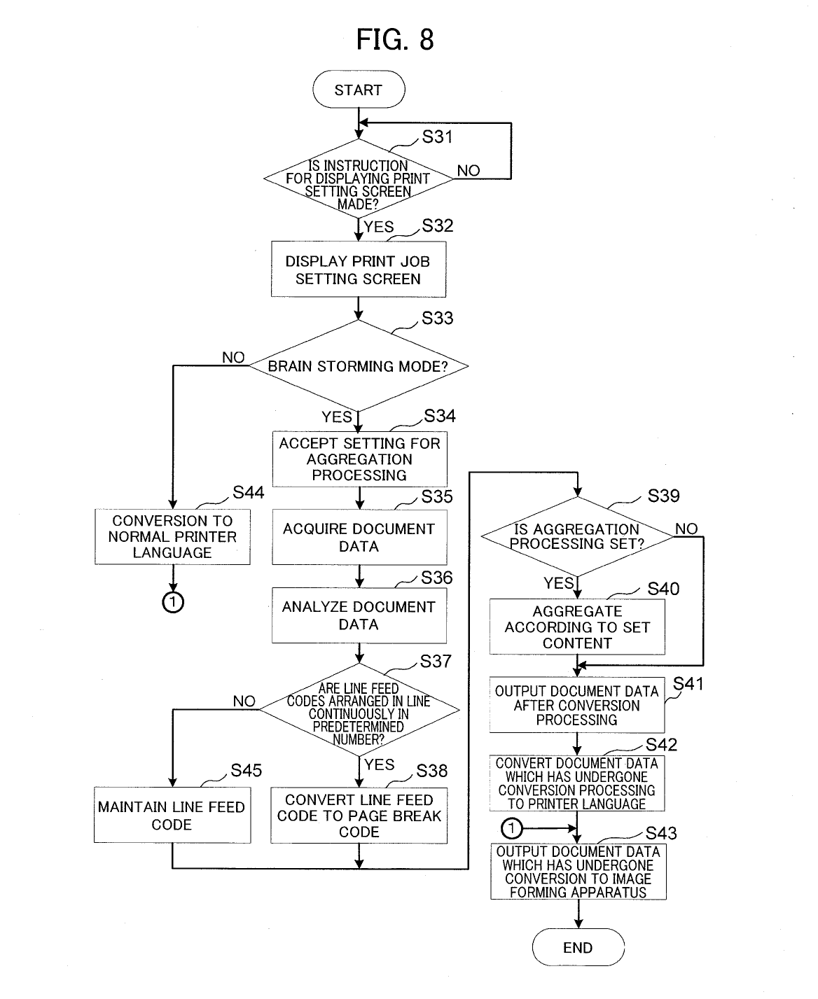

Next, a third embodiment of the execution processing of a print job with the PC 1 will be described. FIG. 8 is a flow chart showing a third embodiment of the execution processing of the print job with a PC 1. Description of the same processing as the first or second embodiment is omitted.

According to the third embodiment, after an analysis processing of document data by the analysis portion 103 (S36), the page break processing portion 104 determines whether the line feed codes, which is an example of the first character contained in the document data, are arranged in line continuously in a predetermined number (S37). When the page break processing portion 104 determines that the line feed codes contained in the document data are arranged in line continuously in the predetermined number (YES in S37), the page break processing portion 104 converts the predetermined number (e.g., two or more) of the continuous line feed codes to page break codes (S38). That is, the page break processing portion 104 performs the page break processing at every position where the line feed codes are arranged in line continuously in the predetermined number.

Unless the page break processing portion 104 determines that line feed codes contained in the document data are arranged in line continuously in the predetermined number (NO in S37), the page break processing portion 104 skips the conversion of the line feed codes to the page break codes and maintains the page break codes as they are (S45).

After that, the same processing as those of S18 to S22 in the second embodiment are carried out (S39 to S43).

According to the third embodiment, when creating a document data with a word processor or the like, depending on whether the first characters are to be input in any predetermined number, the operator can selectively use the first character as a character indicating a letter or a symbol which is a part of the document or use the first character as a character indicating an instruction for executing the above-described page break processing.

Although the third embodiment indicates a case where the aggregation processing is carried out in S34, S39, and S40, the aggregation processing is not an indispensable processing in the third embodiment. That is, the third embodiment may be constructed so that the page break processing is carried out based on the first characters arranged in line continuously in the predetermined number without performing the aggregation processing.

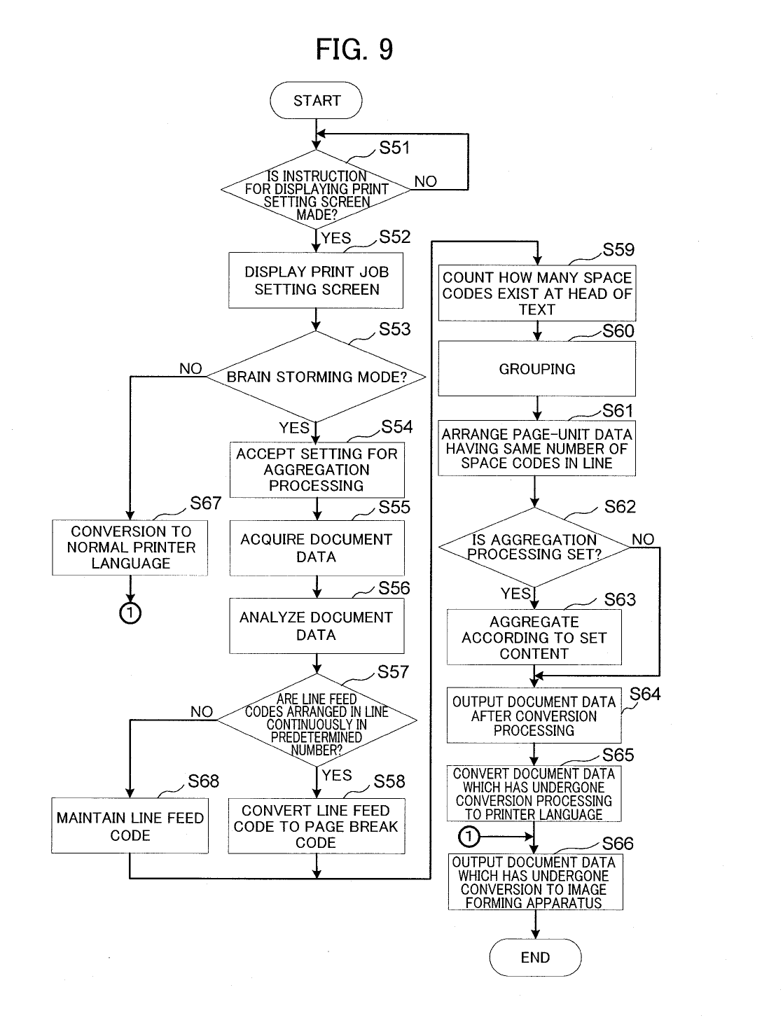

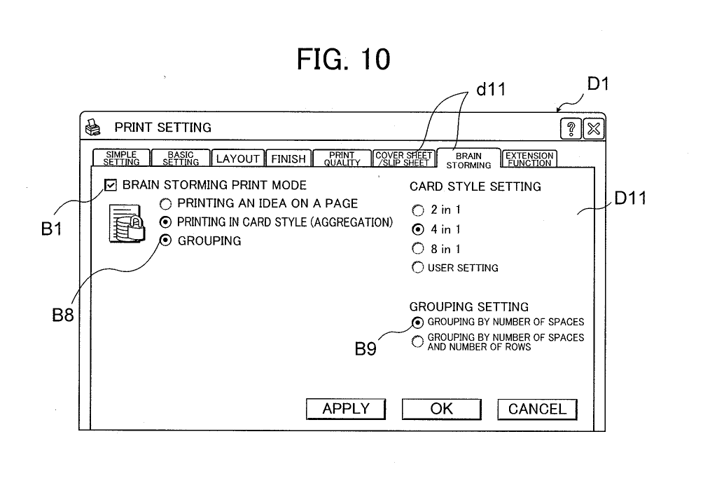

Next, a fourth embodiment of the execution processing of a print job with the PC 1 will be described. FIG. 9 is a flow chart showing a fourth embodiment of the execution processing of the print job with the PC 1. FIG. 10 is a diagram showing an example of a display screen of the display portion. Description of the same processing as the first to the third embodiments is omitted.

According to a fourth embodiment, the page-unit data which are divided to each page undergo a further processing for being grouped.

For example, as shown in FIG. 10, the operator specifies a radio button B1 indicating the “brain storming print mode” by operating a mouse pointer serving as the input portion 119 on the brain storming setting screen, and further, specifies a radio button B8 indicating “grouping”. Then, the control portion 101 controls the display portion 115 to change a display portion of “grouping setting” for accepting the grouping, indicated adjacent to the display portions of the “brain storming print mode” and the “grouping” from gray-out to a representation indicating a state in which an instruction can be accepted.

With this state, the operator specifies a radio button B9 indicating “grouping by the number of spaces” in the display portion of “grouping setting” by operating a mouse pointer or the like which serves as the input portion 119, and the first reallocation processing portion 108 accepts an instruction for executing further grouping of the page-unit data. Consequently, a processing for grouping the page-unit data, which will be described below, is carried out.

According to the fourth embodiment, after a processing for converting the line feed codes as the first character which reside continuously in the predetermined number to the page feed codes (S58) or a processing for maintaining the line feed codes (S68), by the page break processing portion 104, the first reallocation processing portion 108 counts how many predetermined second characters (in the present embodiment, space codes) exist at the head of text of page-unit data on each divided page (S59). As the second character, a different character from the first character is used.

The first reallocation processing portion 108 groups the page-unit data depending on the number of the second characters at the head of text (S60). For example, the first reallocation processing portion 108 classifies page-unit data having a space code at the head of text as a first group, page-unit data having two space codes at the head of text as a second group, . . . and page-unit data having n space codes as nth group and divides them into groups.

Of the page-unit data of each group classified by the grouping, the first reallocation processing portion 108 changes the layout such that the page-unit data of the same group are arranged continuously and arrange those page-unit data in that manner (S61). In the present embodiment, although the first reallocation processing portion 108 arranges the groups in the order from a group having a smaller number of space codes, the arrangement order is not limited to this example. As regards the order of arrangement of the groups, those groups may be arranged in the order from a group having a larger number of the space codes or in an order specified by the operator through an operation of the input portion 119.

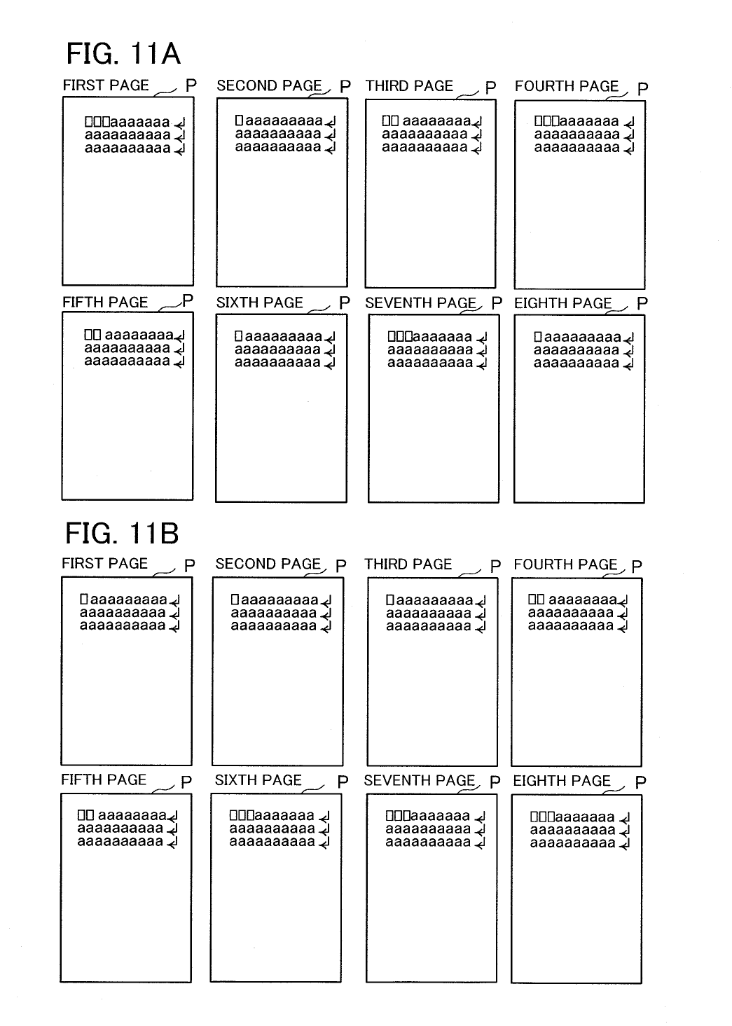

FIG. 11A shows a layout of a document expressed by document data after the page break processing is performed. FIG. 11B shows a layout of a document expressed by document data after the reallocation processing is carried out based on the grouping.

For example, as shown in FIG. 11A, if the page-unit data of a first page has three space codes at the head of text, the page-unit data of a second page has a space code at the head of text, the page-unit data of a third page has two space codes at the head of text, page-unit data of fourth page has three space codes at the head of text, the page-unit data of a fifth page has two space codes at the head of text, the page-unit data of a sixth page has a space code at the head of text, the page-unit data of a seventh page has three space codes at the head of text, and the page-unit data of an eight page has a space code at the head of text, then, the first reallocation processing portion 108 changes the order of page arrangement so that the unit-page data having a space code are arranged on the first page to the third page, the unit-page data having two space codes are arranged on the fourth and fifth pages and the unit-page data having three space codes are arranged on the sixth to eighth pages.

After that, the same processing as the processing of S18 to S22 of the second embodiment is carried out (S62 to S66). However, in the fourth embodiment, no aggregation processing shown in S62 to S66 is indispensable.

Although, according to the fourth embodiment, depending on the number of the second characters which each page-unit data presented as a single page has at its head, the first reallocation processing portion 108 performs the above-described allocation processing, it may perform a following allocation processing instead thereof. For example, (1) it is permissible to perform the above-described allocation processing depending on a number of second characters which each page-unit data presented as a single page has at its end of the text. (2) Alternatively, it is also permissible to perform the allocation processing depending on a number of second characters which each page-unit data presented as a single page has both at the head and end of the text (it is assumed that numbers of second characters at the head and end of text in single page-unit data are equal).

According to the fourth embodiment, when an operator inputs text indicating an idea via a personal computer having a function for a text editor or a word processor for the purpose of the brain storming, by inputting a same number of second characters into the head or the end or into both the head and the end of respective texts (paragraphs) which he or she wishes to arrange in line continuously, texts indicating approximate idea (texts indicated by the page-unit data) can be arranged at an aggregate position easily.

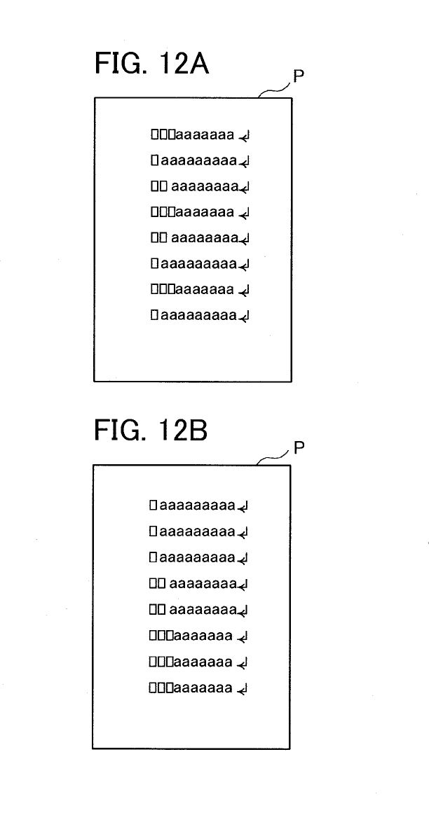

Furthermore, according to the fourth embodiment, as shown in FIG. 9, upon text data which the above page break processing portion 104 has not performed the page break processing (NO in S57, S68), the first reallocation processing portion 108 performs the above allocation processing depending on a number of second characters which page-unit data of each page has (S59 to S61). In this case, the first reallocation processing portion 108 performs the allocation processing depending on the number of the second characters which respective paragraphs arranged in text data without the page break processing have. Consequently, instead of the page orders of the page-unit data being changed depending on each group as described above, the first reallocation processing portion 108 reallocates the respective paragraphs arranged in text data without any page break as shown in FIG. 12A, so that they are grouped depending on the number of second characters which each paragraph has and the paragraphs in each group are arranged continuously as shown in FIG. 12B.

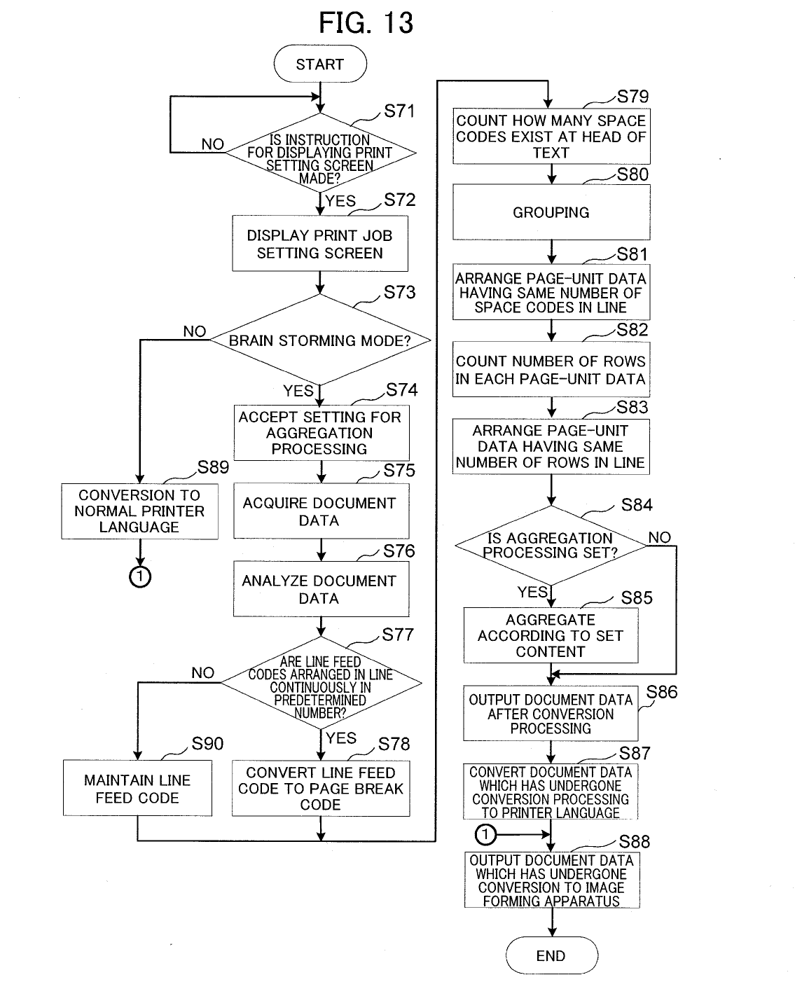

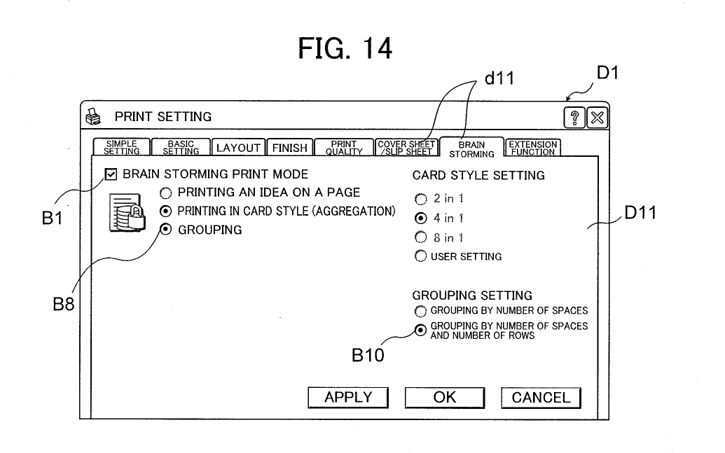

Next, a fifth embodiment of the execution processing of a print job with the PC 1 will be described. FIG. 13 is a flow chart showing the fifth embodiment of the execution processing of the print job with the PC 1. FIG. 14 is a diagram showing an example of a display screen of the display portion. Description of the same processing as the first to the fourth embodiment is omitted.

According to the fifth embodiment, the first reallocation processing portion 108 performs the above allocation processing depending on the number of the second characters which the page-unit data of each page has at its head (S81). After that, the second reallocation processing portion 109 detects a number of rows of each page-unit data in each group (S82), and classifies the page-unit data having the same number of rows in each group to further groups so that the page-unit data having the same number of rows are arranged continuously in the each group (S83). Alternatively, the second reallocation processing portion 109 detects a number of rows of each paragraph in each group (S82) and classifies the paragraphs having the same number of rows in each group so that the paragraphs having the same number of rows are arranged continuously in the each group (S83).

For example, as shown in FIG. 14, the operator specifies the radio button B1 indicating the brain storming print mode by operating a mouse pointer serving as the input portion 119 on the brain storming setting screen D11, and additionally, specifies a radio button B8 indicating grouping. Furthermore, the operator specifies a radio button B10 indicating “grouping by the number of spaces and number of rows” at a display portion of “grouping setting” by operating a mouse pointer serving as the input portion 119. Then, an instruction for executing the reallocation processing depending on the number of rows is accepted by the second reallocation processing portion.

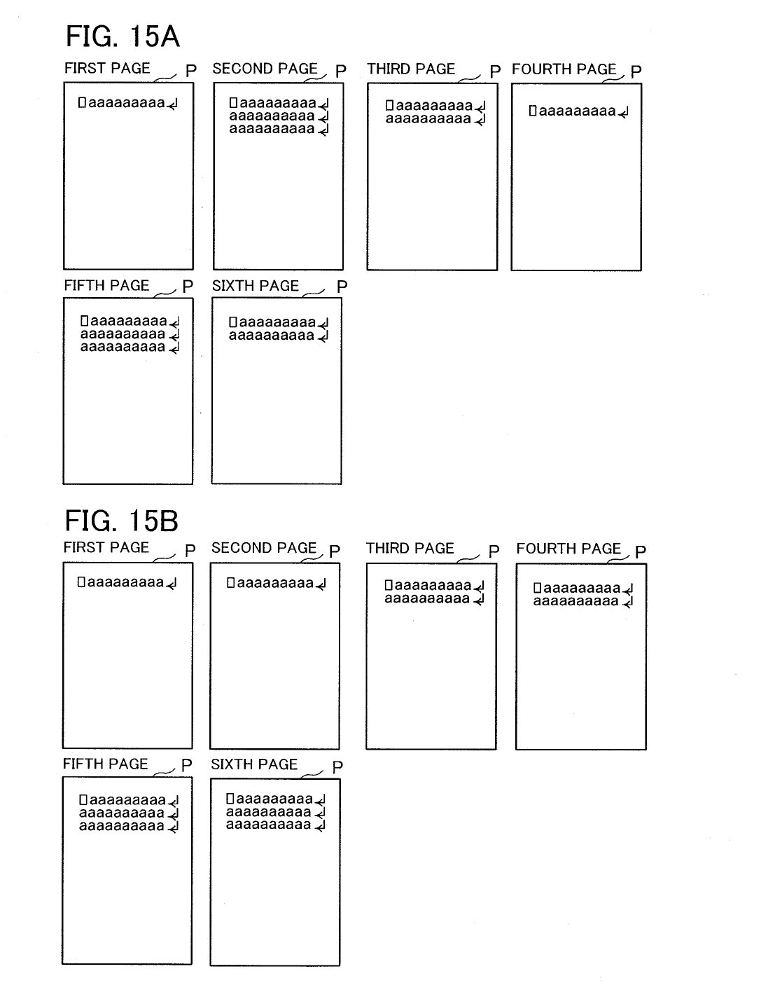

For example, as shown in FIG. 15A, assume a group of page-unit data in which a first page to a sixth page have a single space code while the first page has a single row, the second page has three rows, the third page has two rows, the fourth page has a row, the fifth page has three rows and the sixth page has two rows. As shown in FIG. 15B, the page order of those pages is changed so that in the group of the first page to the sixth page, the first page has a single row, the second page has a single row, the third page has two rows, the fourth page has two rows, the fifth page has three rows and the sixth page has three rows.

After that, the same processing as those of S18 to S22 in the second embodiment are carried out (S84 to S88). However, the aggregation processing indicated by S84 to S88 is not indispensable in the fifth embodiment.

According to the fifth embodiment, when the operator inputs text expressing his or her idea via a personal computer having a function of a text editor or a word processor for the purpose of brain storming, if he or she performs an input operation by equalizing numbers of rows of texts which he or she wishes to arrange in succession, the texts expressing an approximate idea can be arranged at an aggregate position easily.

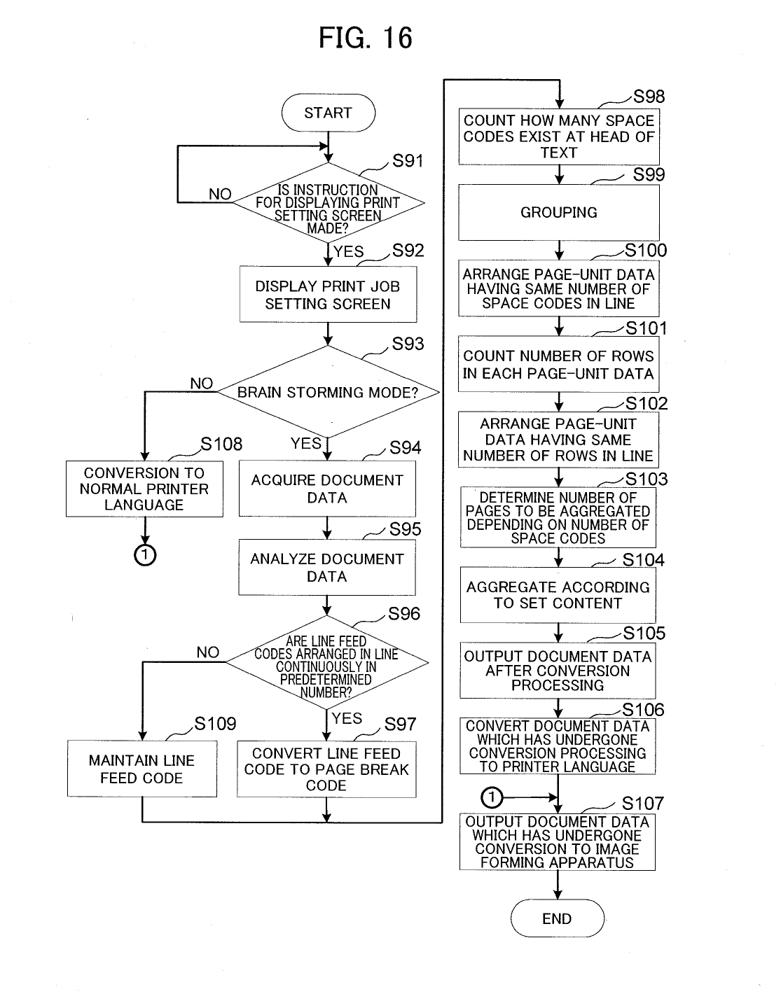

Next, a sixth embodiment of the execution processing of a print job with the PC 1 will be described. FIG. 16 is a flow chart showing a sixth embodiment of the execution processing of a print job with the PC 1. Description of the same processing of the first to fifth embodiment is omitted.

In the sixth embodiment, no aggregation processing based on an aggregation setting according to an operator's instruction is performed. After the reallocation processing based on the number of rows by the second reallocation processing portion 109 (S102), the aggregation processing portion 107 determines the number of pages to be aggregated depending on a number of the second characters which the reallocated page-unit data has (S103). For example, the aggregation processing portion 107 has a data table which stores an aggregation setting (2 in 1, 4 in 1, 8 in 1, etc. as described above) corresponding to the number of the second characters, and reads an aggregation setting corresponding to the number of the second characters which the reallocated page-unit data has from the data table to determine an aggregation setting corresponding to the number of the second characters.

The aggregation processing portion 107 aggregates respective page-unit texts by a page unit specified by an aggregation instruction (S104) along with the number of pages to be aggregated thus determined.

However, in the sixth embodiment, it is permissible to skip the reallocation processing by the second reallocation processing portion 109 indicated by S101 and S102.

According to the sixth embodiment, when the operator inputs text expressing his or her idea via a personal computer having a function of a text editor or a word processor for the purpose of brain storming, if he or she performs an operation of differentiating the number of the second characters depending on the number of pages to be aggregated, respective texts expressing each favorable idea can be printed collectively on a single recording paper by an easy operation.

A configuration and advantages of the present disclosure are summarized as follows. According to the present disclosure, if the first character determined preliminarily by analysis of the analysis portion is contained in document data acquired by the document data acquisition portion, the page break processing portion performs the page break processing at a position of the first character and the output portion outputs document data which has undergone the page break processing. Thus, if an operator creates document data by inputting the first character at a desired position when he or she inputs letters or symbols via a personal computer having a function of a text editor or a word processor, the document data is acquired by the document data acquisition portion without any layout setting operation. According to the document data acquired consequently, pages are broken at the position where the first character is input, so that each text contained in the document data is printed on an independent page. Thus, by performing an operation of inputting the first character at a desired position via the personal computer or the like, the operator can print each text on an independent recording paper each time when the input position of the first character appears.

Consequently, to extract ideas according to the brain storming method, it is possible to form proposed ideas into electronic data by inputting letters and symbols via the personal computer and print those ideas in a print format necessary for the brain storming, i.e., in such a format that each text indicating an idea is printed on an independent recording paper by an easy operation.

A data processing program which makes a computer function can be stored (recorded) non-temporarily in a computer-readable recording medium as well as a ROM and hard disk of the computer. An external storage device refers to memory expansion device which contains a storage medium such as compact disk-read only memory (CD-ROM) and is connected to an external electronic device. A portable storage medium refers to a storage medium which can be mounted to a recording medium drive unit and carried, such as a flexible disk, memory card, magneto-optical disk. A program recorded in a recording medium is loaded on a RAM of a computer and executed by a central processing unit (CPU). The function of the computer is achieved by the execution of the program.

In addition, the present invention is not restricted to the above-described configurations but may be modified in various ways. The configurations (apparatus) and processing (method) expressed in the above-described respective embodiments with FIGS. 1 to 16 are only an embodiment of the present invention but it is not intended that the present disclosure is limited to those configurations and processing.

1. A data processing apparatus comprising:
a document data acquisition portion that acquires document data;
an analysis portion that analyzes characters constituting the document data acquired by the document data acquisition portion;
a page break processing portion that when the character analyzed by the analysis portion indicates a predetermined first character, performs page break processing at a position of the first character; and
an output portion that outputs the document data that has undergone the page break processing by the page break processing portion.

2. The data processing apparatus according to claim 1, further comprising:
an aggregation acceptance portion that accepts a setting for aggregation processing by an operator; and
an aggregation processing portion that executes an aggregation processing based on the setting accepted by the aggregation acceptance portion, on page-unit data presented by dividing the document data by the page break processing,
wherein the output portion outputs the document data that is constituted of the page-unit data and has undergone the aggregation processing by the aggregation processing portion.

3. The data processing apparatus according to claim 1, wherein the page break processing portion, when the first characters reside continuously in a predetermined number, performs the page break processing at a position where the first characters reside continuously in the predetermined number.

4. The data processing apparatus according to claim 1, further comprising a reallocation processing portion that, of page-unit data, extracts page-unit data having predetermined second characters different from the first character that reside continuously in the same number thereof at least at any one of the head and the end of text and arrange the extracted page-unit data continuously.

5. The data processing apparatus according to claim 1, further comprising a second reallocation portion that detects a number of rows that each page-unit data has and rearranges the page-unit data having the same number of the rows continuously.

6. The data processing apparatus according to claim 4, wherein the aggregation processing portion aggregates reallocated page-unit data having the same number of the second characters or the rows on a predetermined number of different pages depending on the number of the second characters or the number of the rows.

7. A non-temporary recording medium that records a data processing program configured to make a computer function and is computer-readable,
wherein the data processing program makes the computer function as:
a document data acquisition portion that acquires document data;
an analysis portion that analyzes characters constituting the document data acquired by the document data acquisition portion;
a page break processing portion that, when a character analyzed by the analysis portion indicates a predetermined first character, performs page break processing at a position of the first character; and
an output portion that outputs the document data that has undergone the page break processing by the page break processing portion.

8. A data processing method comprising:
acquiring document data;
analyzing characters constituting the acquired document data;
when the analyzed characters indicate a predetermined first character, performing page break processing at a position of the first character; and
outputting the document data that has undergone the page break processing.
